(19) United States
(12) Patent Application Publication
(10) Pub. No.: US 2021/0018455 A1
(43) Pub. Date: Jan. 21, 2021

(54) COPPER OXIDE NANOSENSOR

(71) Applicant: OKINAWA INSTITUTE OF SCIENCE AND TECHNOLOGY SCHOOL CORPORATION, Kunigami-gun, Okinawa (JP)

(72) Inventors: Mukhles Ibrahim Sowwan, Kunigami-gun (JP); Alexander James Porkovich, Kunigami-gun (JP); Jerome Vernieres, Kunigami-gun (JP); Stephan Steinhauer, Kunigami-gun (JP); Zakaria Ziadi, Kunigami-gun (JP)

(73) Assignee: OKINAWA INSTITUTE OF SCIENCE AND TECHNOLOGY SCHOOL CORPORATION, Kunigami-gun, Okinawa (JP)

(21) Appl. No.: 16/981,117

(22) PCT Filed: Mar. 11, 2019
(86) PCT No.: PCT/JP2019/011023

§ 371 Date: Sep. 15, 2020

Related U.S. Application Data
(60) Provisional application No. 62/644,361, filed on Mar. 16, 2018.

(51) Int. Cl. G01N 27/12; C01G 3/02; C23C 28/00

(52) U.S. Cl. CPC G01N 27/125; C01G 3/02; B82Y 15/00; C01P 2004/16; C01P 2004/03; C23C 28/322

(57) ABSTRACT

A system and method of nanoparticle deposition for achieving an acetone sensitive response based on ruthenium decorated CuO nanowires at temperatures of 200° C. and 250° C. is disclosed. This method is useful for building sensors. The method used to build the sensor is easily integrable into silicon technology broadly, and into a CMOX compatible device specifically. Additionally, it is expected that this method of nanoparticle deposition can be transferred to other MOx nanowire sensors, such as but not limited to zinc oxide nanowire.

### BACKGROUND OF THE INVENTION

Acetone detection is a matter of high interest in the field of gas sensor research. A highly useful solvent across many scientific areas, acetone produces fumes which are highly hazardous to human health. Additionally, detection of sub-ppm levels of acetone has become an area of interest in the bio-medical fields, as new research shows acetone is a possible bio-marker in various diseases including ketosis, heart failure and diabetes. Acetone sensors which can operate in this range are therefore highly promising as a means to provide non-invasive diagnosis of health problems.

Metal oxide (MOx) based gas sensors are a class of semi-conductive sensors which measure gas concentration through resistance measurements. These sensors come in a variety of geometries including metal-organic frameworks, thin films, microspheres, nanospheres mesoporous nanoparticle thin films, nanosheets, nanoflowers, nanowires and other nanostructures. Nanowires are of particular interest, as their 1-dimensional structure provides a high surface area, thereby providing increased sensitivity to gases. Of particular note are copper oxide (CuO) nanowires which have a very low band gap (1.2 eV-1.9 eV) and can be synthesised easily via thermal oxidation. It is also possible to have copper oxide nanowires fabricated on chips, allowing for CMOX integration.

One drawback of MOx based gas sensors is that they operate above room temperature, which requires more energy.

Monodispersed noble metal nanoparticles on oxide supports have long been a method to lower the temperatures required to decompose volatile organic compounds (VOCs). One such noble metal is ruthenium, which has been used in an oxygen reduction capacity at temperatures lower than the operating temperatures of many MOx gas sensors. As such, ruthenium is sometimes used within MOx based gas sensors.

It has previously been demonstrated that a gas-aggregation based nanocluster source can be used to functionalise MOx nanowires via nanoparticle deposition. Inert gas condensation methods of nanoparticle growth has been demonstrated to produce complex, sophisticated structures, owing to the fast kinetics and non-equilibrium processes that it entails. In addition, using a physical deposition process enables better integration of these nanoparticles into silicon technology, as doing so avoids contaminations from solvents and provides a more homogenous distribution than spin coating.

### SUMMARY OF THE INVENTION

The embodiments herein are directed to, among other things, a gas sensor for ultra low concentrations of acetone vapor. The way the sensor is fabricated allows it to be directly integrated with a computer chip, and subsequently directly into a functional device. Acetone in human breath is currently being studied as a biomarker for various diseases, meaning this device may have value as a non-invasive diagnostic tool.

### BRIEF DESCRIPTION OF DRAWINGS

FIGS. 1A, 1B, 1C, 1D, 1E, and 1F collectively form a diagram outlining the process of CuO nanowire sensor construction;

FIG. 2 shows a scanning electron microscope image of a completed sensor;

FIG. 3A shows a relative response ‘r’ of a pristine CuO nanowire sensor to acetone gas at different operating temperatures, while FIG. 3B shows the response of the sensor to different concentrations of acetone at different temperatures;

FIG. 4A shows a size distribution of the ruthenium nanoparticles deposited. FIG. 4B shows a low magnification transmission electron micrograph showing the surface coverage of ruthenium nanoparticles. FIG. 4C shows a high magnification image of the ruthenium particles. FIG. 4D shows a hcp structure of the nanoparticles confirmed by a Fast-Fourier Transform;

FIG. 5A shows decoration of the CuO nanowires with ruthenium particles before gas testing;

FIG. 5B shows decoration of the CuO nanowires with ruthenium particles after gas testing;

FIG. 6A shows a resistance response ‘r’ of ruthenium decorated CuO nanowires to acetone at operating temperatures of 200° C.;

FIG. 6B shows a resistance response ‘r’ of ruthenium decorated CuO nanowires to acetone at operating temperatures of 250° C.;

FIG. 7A shows an average response of the ruthenium decorated nanoparticle CuO nanowire sensors to acetone operating at temperatures of 200° C.;

FIG. 7B shows an average response of the ruthenium decorated nanoparticle CuO nanowire sensors to acetone operating at temperatures of 250° C.;

FIG. 8A shows a growth chamber and a pressure chamber;

FIG. 8B shows a detailed view of the growth chamber of FIG. 8A; and

FIG. 9A shows a first view of a sensor's interaction with dry air and separately with acetone. FIG. 9B shows a second view of a sensor's interaction with dry air and separately with acetone.

### DETAILED DESCRIPTION OF THE PREFERRED EMBODIMENTS

The embodiments herein include but are not limited to methods of developing a copper oxide nanowire-based acetone sensor which is capable of operating at temperatures of e.g. 250° C. and 300° C., and also having the capacity to detect acetone concentrations as low as 50 ppb. Decorating the nanowires with ruthenium nanoparticles can reduce the operating temperature to 200° C., while significantly improving the signal during operation of the sensor with respect to acetone at a temperature of 250° C. The arrangements discussed herein are capable of detecting e.g. 10 ppb and 25 ppb of acetone respectively (with the capacity for further responses at lower concentrations).

For example purposes and illustrative purposes only, the example of sensing acetone will be used. However, the various embodiments of sensors disclosed herein should not be considered as limited exclusively to acetone.

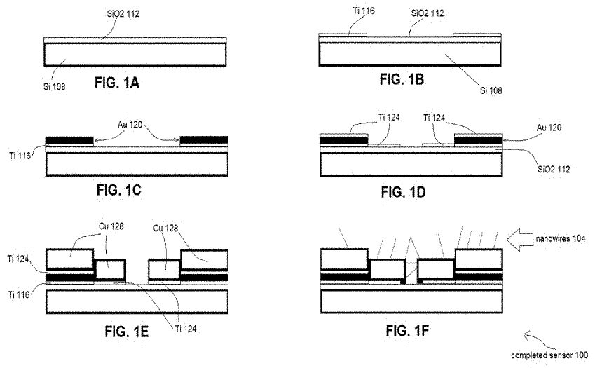

FIGS. 1A-1F demonstrate the steps in the fabrication process of a CuO nanowire sensor 100. As shown in FIG. 1A, a sensor 100 is fabricated on a substrate of Si wafer 108 with a SiO₂ layer 112 positioned atop the Si wafer 108. A Ti adhesion layer 116 is then deposited on the Sift layer 112, as shown in FIG. 1B. A layer of Au 120 is then deposited on the Ti layer 116 to serve as electrical contacts, as shown in FIG. 1C. Another Ti layer 124 is deposited partially on the SiO₂ layer 112 and the Au layer 120, as shown in FIG. 1D.

FIG. 1E illustrates that the Ti layer 124 acts as a diffusion barrier for the Cu layer 128 deposited thereupon. Meanwhile, the Cu layer 128 will act as electrodes in the completed sensor 100. Finally, a gap between the Cu electrodes was bridged through the growth of CuO nanowires 104 between the electrodes 100. This final step can be accomplished via thermally oxidising the Cu at a predetermined temperature in ambient atmosphere, the results of which are shown in FIG. 1F. In an embodiment, the predetermined temperature can be 350° C.

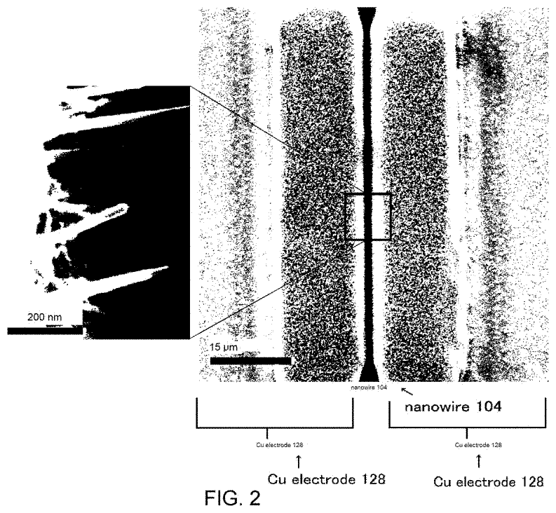

FIG. 2 shows two scanning electron microscope (SEM) views of an example interior of a completed sensor 100. The inset depicting the gap between Cu electrodes 128 shows the growth of CuO nanowires 104 forming a semi-conductive path. These CuO nanowires 104 form the sensitive, information-gathering part of the sensor 100. The gap between the copper oxide regions is bridged by nanowires forming a high resistance (e.g. 10's of GΩ) semi-conducting path at room temperature.

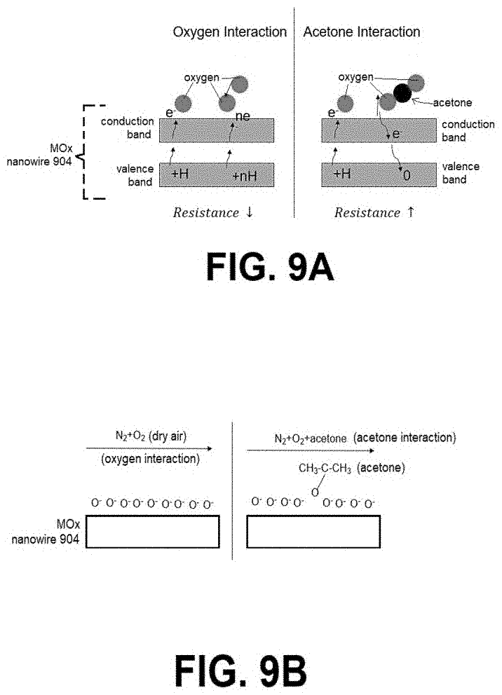

A key factor within the MOx semi-conductive sensors 100 described herein is that when acetone chemisorbs onto the surface of the MOx, the resulting reaction between the chemisorbed oxygen and acetone (Equation 1) results in the CuO surface being reduced, resulting in less surface oxygen and a subsequent release of negative charge into the conduction band (discussed in more detail with respect to FIGS. 9A and 9B). As CuO is a P-type semiconductor, this release will be observed as an increase of resistance, measured as a decrease in current.

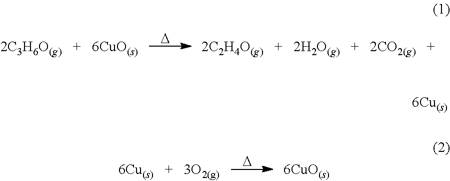

Conversely, when acetone is not present, the oxygen in the atmosphere surrounding the Cu nanowires will once again be chemisorbed onto the copper surface (Equation 2), a process accelerated by the elevated temperature, resulting in a subsequent increase in surface oxygen. This results in a flow of negative charge out of the conduction band (see FIG. 9), and is visible as a subsequent decrease in resistance.

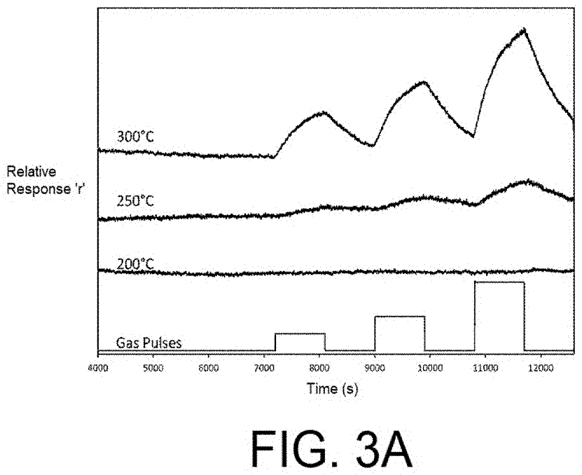

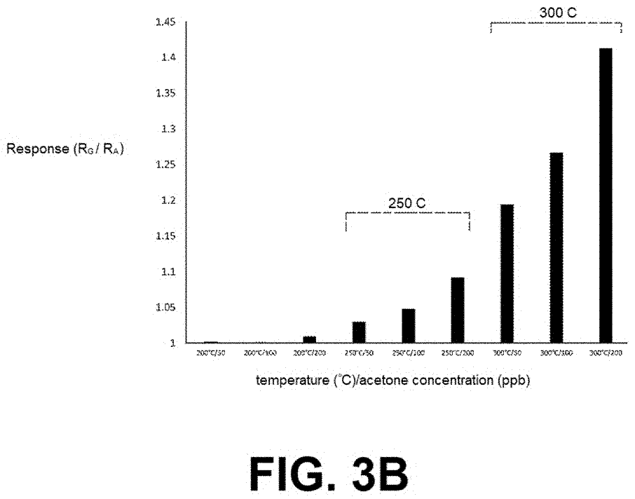

As shown in FIGS. 3A and 3B, the CuO nanowires 104 showed a current flow in the ranges of 10⁻⁸ A (10's of nanoamperes), 10⁻⁷ A (100's of nanoamperes) and 10⁻⁶ A (microamperes) for temperatures of 200° C., 250° C. and 300° C. respectively, using a bias voltage of 0.5V.

FIG. 3A shows a relative response of a pristine (bare, undecorated) CuO nanowire sensor 100 to acetone gas at different operating temperatures. The gas pulses at the bottom of FIG. 3A represent 50, 100 and 200 ppb of acetone respectively. It can be seen in FIG. 3A that there is no response to acetone at 200° C., while at 250° C. there is a small but significant response coinciding with the gas pulses. Once operating at 300° C., the sensor shows a much higher response to acetone.

FIG. 3B shows the response of the sensor to different concentrations of acetone at different temperatures. The response ‘r’ is defined as the resistance at the end of the gas pulse divided by the resistance before the gas pulse. A lower case r is chosen, and should be understood to mean “response” and not “resistance”. Resistance will continue to be represented by an upper case R.

A the response of a particular nanowire is calculated by the equation:

$$r = \frac{{R}_{G}}{{R}_{A}}$$

Where r is the response, R_{G} is the resistance value at the end of the gas pulse and R_{A} is the resistance value of the sensor in dry synthetic air. As this is a p-type semi-conductor and reducing gas combination, the response should have a higher resistance at the end of the gas pulse than in dry synthetic air, leading to ‘r’ having values above unity (above 1.0).

During the experiments documented within FIGS. 3A and 3B, a constant 0.5V Voltage was applied to each sensor 100. The experiments are performed in a sealed chamber, where the sensor temperature is controlled by a hotplate within the chamber, the experiment is stabilised for 5 hr with a dry synthetic air flow, and acetone is flowed with dry air in 15 minute “on/off” pulses, where, as stated, each pulse is related to a different concentration of acetone.

Interpreting FIG. 3B a bit further, operating at 250° C. shows a 10% response to 200 ppb of acetone, while at 300° C., 50 ppb of acetone is already registering a 20% response.

One purpose of decorating the nanowires with ruthenium nanoparticles is to increase the response ‘r’ of the nanowire sensor 100, either at 300° C. or at a lower temperature. Ruthenium was chosen to illustrate the principles herein because of its capacity as a catalyst, especially within organic processes. However, other elements and/or combination of elements could also be used in place of ruthenium, for at least the reason that ruthenium can be expensive comparied to other elements. Ruthenium nanoparticles have the advantage of being catalytically active with CuO.

From FIG. 3A it is apparent that CuO sensors 100 had zero (flat) response operating at 200° C. Meanwhile, FIG. 3A also shows somewhat weak responses observed at 250° C. temperature, with significant improvement in signal when operating at 300° C. Next, one purpose of the techniques of decoration described herein is to improve signal, improve selectivity, protect the surface of the MOx and/or reduce temperature required for operation.

As such, it is apparent that a kind of “trade off” exists. FIG. 3A shows that selectivity goes up when temperature goes up, so the end-purchasers of the sensor 100 are left with a choice. If the end-purchaser only needs a moderate selectivity, they can select to operate the sensor 100 at the lower temperature, and the sensor 100 consumes less power. Conversely, if they need better selectivity, they have to suffer a bit of increase in temperature, which means the sensor 100 consumes more power.

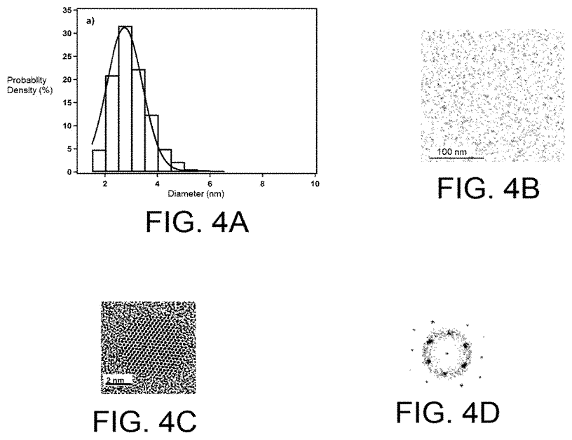

FIGS. 4A and 4B show well-controlled size distribution of the ruthenium nanoparticles, with a mean diameter of 2.8 nm and a standard deviation of 0.9 nm (FIG. 4A), and being evenly dispersed (FIG. 4B). Specifically, FIG. 4B is a low magnification transmission electron micrograph showing the surface coverage of ruthenium nanoparticles after 100 minutes. An example of the ruthenium nanoparticles which were deposited can be seen in FIG. 4C, where the high magnification demonstrates a Hexagonal Close Packed (HCP) structure. This HCP structure is confirmed by the Fast-Fourier Transform of the particle shown in FIG. 4D.

As stated, the ruthenium nanoparticles were deposited directly on the sensor 100 for a period of 100 minutes. This specific period of time was chosen in order to achieve a coverage of 6% of the surface area of the sensor 100, which is sufficient to achieve the desired change in resistance.

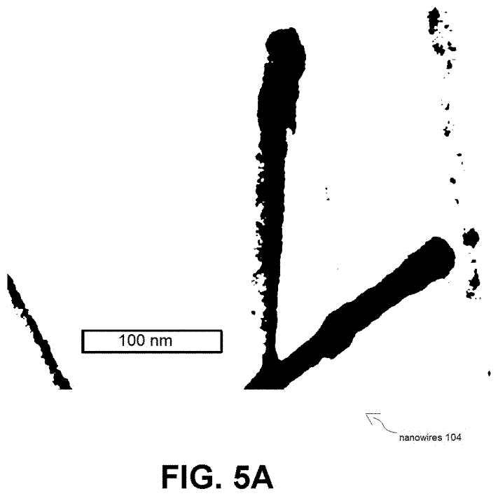

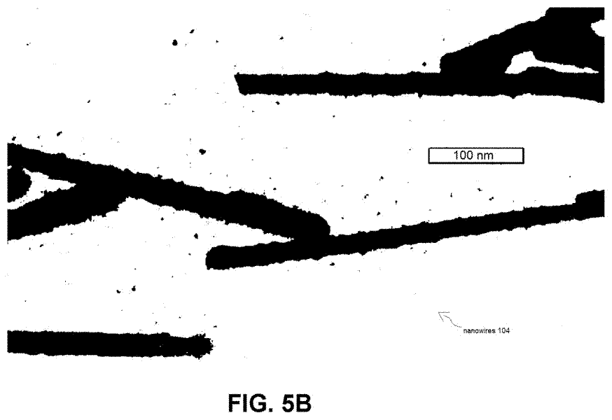

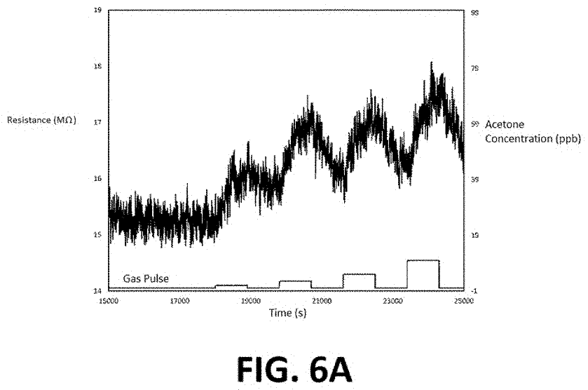

FIG. 5A shows example decorations (covering) of the CuO nanowires 104 with ruthenium particles before gas testing, while FIG. 5B shows example decorations after gas testing. FIGS. 5A/5B demonstrate that the nanowires 100 are highly covered by the ruthenium nanoparticles and remain so during use. That is, the SEM images of FIGS. 5A/5B do not show a significant difference in the nanoparticles coverage or size before use (FIG. 5A) and after use (FIG. 5B).

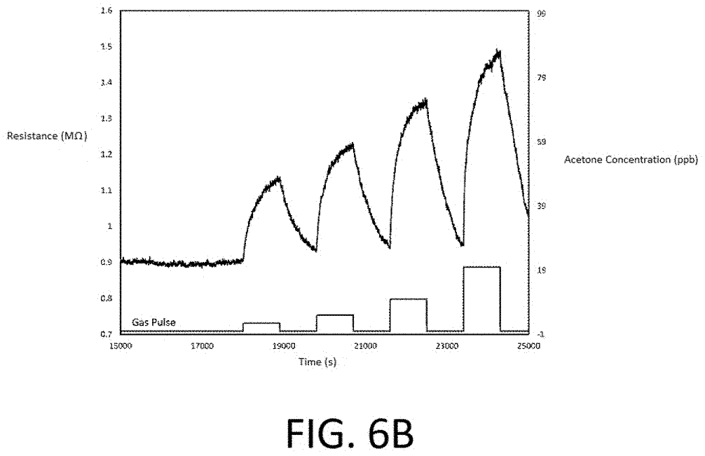

FIGS. 6A and 6B show a resistance response of ruthenium decorated CuO nanowires to acetone at operating temperatures of 200° C. (FIG. 6A) and 250° C. (FIG. 6B). At 200° C. the sensor response was tested for concentrations of 10, 25, 50 and 100 ppb of acetone, while at 250° C. the sensor was tested at 25, 50, 100 and 200 ppb acetone concentrations. FIGS. 6A and 6B show that at least some resistance increase occurred at all concentrations of acetone for both temperatures.

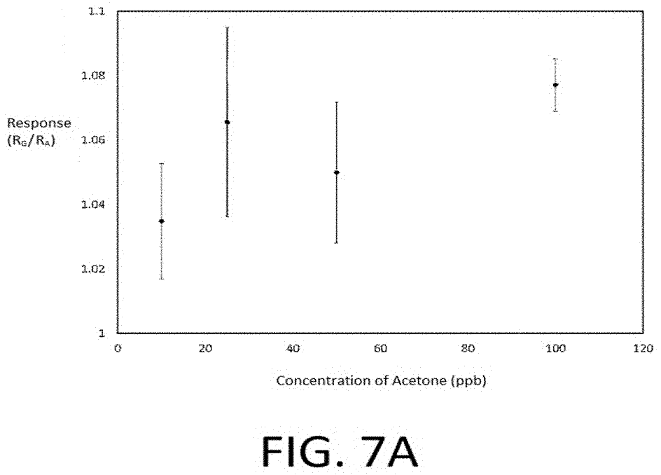

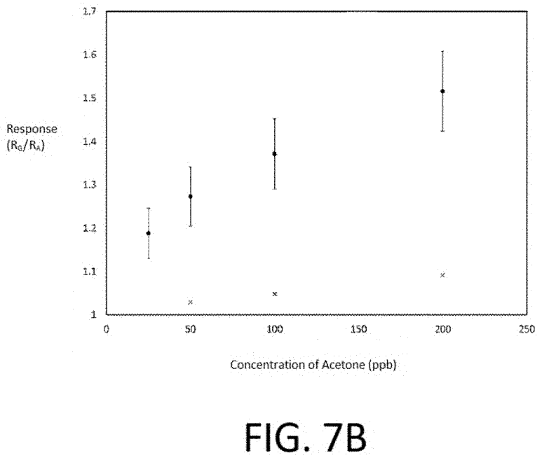

FIGS. 7A and 7B show an average response ‘r’ of the ruthenium decorated nanowire sensors 100 to acetone operating at temperatures of 200° C. and 250° C. Specifically, FIG. 7A shows a large degree of uncertainty in the measurement for a sensor at 200° C. operating temperature, however, there is a definite response at all concentrations from 100 ppb down to 10 ppb. The uncertainty of this measurement may be directly from the sensor 100 itself, or may be due to variables within the measurement. In spite of this uncertainty, it is still clear that the addition of ruthenium nanoparticles has created a response by the CuO nanowires 104 which was not present before. One way of verifying and affirming this finding is the lack of response to 50 and 100 ppb acetone on the pristine CuO nanowires 104, as shown in FIGS. 7A and 7B.

It is apparent from FIG. 7B that operating the sensor 100 at a temperature of 250° C. produces a more consistently linear average response, with a more unified standard deviation. Using the pristine CuO sensor response at 250° C. as a reference (shown in FIG. 7B as a series of crosses), it can be seen that ruthenium functionalisation described herein shows a drastic improvement in signal at this temperature. That is, the crosses in FIG. 7B show the best response of pristine, bare, undecorated CuO nanowires to acetone.

Within the experiment documented by FIGS. 6A and 7A, an applied bias voltage and air flow is the same as detailed in the bare undecorated CuO nanowire sensor 100. A gas concentration of acetone is 10, 25, 50 and 100 ppb is used. The sensor 100 now responds at 200° C. as opposed to a bare, pristine sensor. The response ‘r’ is consistent, however, it is low with less precision. The detection limit can be as low as 10 ppb. In that sense, the 200° C. embodiment is superior to the 250° C. embodiment in detection limit. However, a trade-off is that 200° C. embodiment has a fuzzier response, and has less precision.

Within the experiment documented by FIGS. 6B and 7B, the applied bias voltage and air flow is the same as detailed in bare CuO nanowire sensor. However, the gas concentration of acetone is doubled to 20, 50, 100 and 200 ppb. At 250° C., the sensor 100 now responds far more than the bare CuO sensor (>100% improvement). The response ‘r’ is comparable to or greater than the response of a bare nanowire at 300° C., thus improving energy efficiency. This response is consistent with increased precision, as shown in FIG. 7B. At 250° C., the detection limit is at least 20 ppb, which as stated is inferior to the detection limit at 200° C. However, an advantage is that 240° C. embodiment is clearer, and has greater precision.

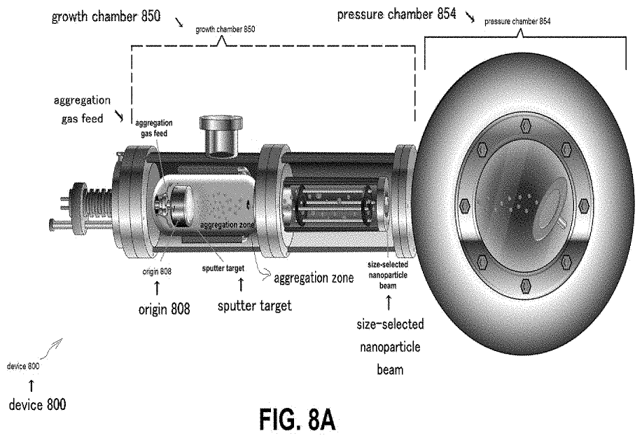

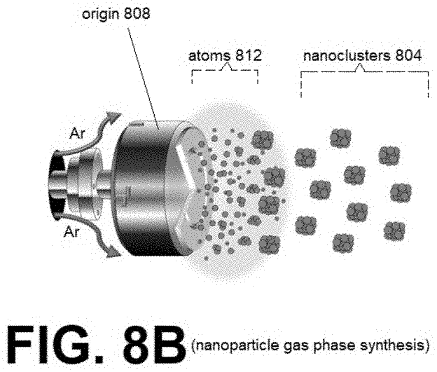

FIGS. 8A and 8B show a device 800 used in creating the sensors 100 described herein. In an embodiment, the device 800 is a magnetron sputterer using inert gas condensation. The device 800 behaves as a nanocluster/nanoparticle source.

The nanoparticles discussed herein are grown by a gas-condensation method partially shown in FIGS. 8A and 8B. FIG. 8B shows a high density of Ar ions and atoms around an origin 808 causing atoms 812 to coalesce into nanoclusters 804. As shown in FIG. 8A, a pressure differential between a growth chamber 850 and a substrate (aggregation) chamber 854 forces the nanoclusters 804 to move from origin 808 to the MOx substrate. In an embodiment, the origin 808 can be a DC magnetron gun.

The nanoclusters 804 have been generated using evaporative sources and laser ablation methods. The idea in each case is the same as plasma, where atoms are removed from a larger material and gas is used to cool the atoms into small clusters of atoms. Laser methods typically generate much smaller particles, as do systems that use liquid nitrogen cooling. Another method that could be used is an aerosol spray pyrolysis method. Overall, the various techniques described herein could all be lumped under gas aggregated synthesis.

Ruthenium (Ru) nanoparticles are chosen because they have narrow size distribution (e.g. a mean size 2.8 nm with st. dev. of 0.9 nm), and optimally can cover as much as approximately 6% of surface of the MOx sensor 100. The Ru nanoparticles are free from surfactants, which is an advantage because surfactants are a significant concern both the environment and to human health.

Some examples of nanoparticle 804 functionalization are shown in FIGS. 9A and 9B. However, prior to discussing the specifics of FIGS. 9A and 9B, some context may be helpful. Nanoparticle functionalization can improve the absorption of acetone or change the charge transfer dynamics of a given MOx nanowire 104. For example, some materials adsorb gases on their surface better than others (generally noble or platinum group metals, e.g. gold, platinum, palladium and ruthenium). If these particles are deposited on a MOx nanowire 104, such as copper oxide (CuO), then they make the process of capturing gases from the atmosphere easier. This capture-process is at first physical and then chemical, which tends to break the gas being adsorbed into different component parts.

This breaking of the gas will then influence a nanowire in one of two ways. The first way is directly, with the broken gas molecule interacting with oxygen on the surface of the MOx nanowire 104. Assuming the MOx is (P-type) copper oxide, the oxygen will be removed from the surface of the sensor 100, resulting in the electron that this oxygen was bound to dropping back to the valance band, thereby decreasing the number of charge carriers (holes) and subsequently reducing current. Alternatively, if the gas is an oxidizing one, the nanoparticle will break the gas apart and allow the oxygen molecule to adsorb on the MOx surface. This extracts more electrons from the valance band, resulting in an increase of charge carriers (holes), and consequently increase its ability to conduct current.

The second way this may work is that the gas interacts directly with the nanoparticle. In this case, the absorbing gas changes the electronic structure of the nanoparticle, which results in a charge transfer between the nanoparticle and the MOx nanowire 104 (i.e. electrons either leave the particle entering the MOx (again assuming P-type MOx) resulting in a reduction of current, or charge leaving the nanowire and entering the nanoparticle, resulting in an increase of current).

Whether one effect is dominant or both effects work is still a subject of debate and research. Nanoparticle functionalization include gold nanoparticles on zinc oxide and palladium nanoparticles on copper oxide for carbon monoxide gas.

FIGS. 9A and 9B are complex diagrams, so some context is now offered. At the top of FIG. 9B, a MOx nanowire 104 composed of CuO is shown, and depicted in two separate states of existence. The left instance is where dry air (N2+O2) is blown across the surface of the MOx nanowire 104. The right instance is where dry air+acetone (N2+O2+acetone) is blown across the surface of the MOx nanowire 104. As shown in FIG. 9A, these states are referred to as “oxygen interaction” and “acetone interaction”.

Within FIG. 9A, the same MOx nanowire 104 as FIG. 9B is shown, with the same two instances of “oxygen interaction” and “acetone interaction”. However, the MOx nanowire 904 is shown divided into two bands, a Conduction Band and a Valence Band.

Within FIG. 9A, the gray dots represent oxygen, and the single black dot represents acetone. The left side of FIGS. 9A and 9B represent oxygen interaction, and the right side represents acetone interaction. Specifically, the right side of FIGS. 9A and 9B shows a representation of the acetone interaction removing an oxygen atom from the surface of the MOx. This results in the electron being held at the surface of the MOx moving back down from the conduction band and into the valence band, where it recombines with electron holes (H). Within FIG. 9A, H stands for electron Hole, not for hydrogen.

The recombination referred to above is represented by a “0” (zero). Thus, the 0 (zero) has nothing to do with Oxygen, this is not an upper-case ‘O’, it is a ‘0’ (zero). This recombination exists because as the electron enters the valence band of the MOx nanowire 104, the electron hole is closed and subsequently its ability to conduct current is reduced. As stated, in a P-type MOx, the more electron holes (H), the more current the MOx nanowire 104 can conduct. When the number of electron Holes are decreased, the resistance of the MOx nanowire 104 is increased, thereby conducting less current.

In the example shown in FIG. 9A, the gray oxygen dot on the left side of FIG. 9 is chemisorbed, meaning that it has taken an electron from the conduction band and trapped that electron at the surface of the MOx nanowire 104. The right side of FIG. 9A is intended to convey that if more oxygen atoms are chemisorbed, there will be more electrons at the surface of the MOx nanowire 104.

As stated, within FIG. 9A, the black dot represents acetone. In the case of acetone, the iconography of FIGS. 9A and 9B is somewhat simplified for the purpose of clarity. The reaction between oxygen and acetone is more complicated than simple gases such as oxygen and carbon monoxide. The reaction is generally believed to be:

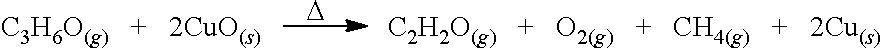

However, different pathways are possible. The black dot represents the entire resulting reaction which removes the oxygen (gray dot) from the surface.

In FIG. 9A, the “e-” represents electrons (having a negative charge thus the “−” symbol), while the +H represents the electron Holes H (not Hydrogen) in the valence band as electrons are moved across the conduction band and into a chemical bond. The electron holes “H” are also known as charge carriers. Recall that in a P-type semiconductor, the movement of the electron Holes H is what conducts current. The n in front of either e or H means a multiplier (n=1, 2, 3, . . . n). For example, if n oxygen atoms land on the surface of the MOx, That means n electrons (ne) are removed from the valence bands, and subsequently n holes (+nH) are created in the valence band. This in turn means the amount of current being transported increases n times.

Finally, in the lower RH corner of FIG. 9A, a 0 (zero) is shown, which was used to show a recombination of electron and electron hole. As stated, the 0 (zero) has nothing to do with oxygen, this is not an upper-case ‘O’, it is a ‘0’ (zero). While oxygen is referenced in FIG. 9A, it is represented by the gray dots, not upper-case ‘O’.

FIG. 9A is intended to show how the MOx nanowire 104 (in this case, copper oxide) works. As stated earlier, the black dot represents a reaction which takes place when acetone reacts with the surface oxide, removing oxygen from the surface of the MOx nanowire 104. Once the oxygen is removed, the resistance is increased. This is shown by the up-arrow at the lower-RH corner of FIG. 9A.

The current moving through the MOx sensor 100 is always being measured. As resistance increases, this current is reduced. Since current is being transported through the sensor 100, resistance is more accurately measured, hence why this class of sensors are known as chemoresistive sensors. As the resistance goes up, the amount of current passing through the MOx nanowire 104 goes down. The change in resistance can be measured by the change in current passing through the MOx nanowire 104. Next, the amount of resistance is directly proportional to the surface area covered by the nanoparticles 804 of the sensor 100, it becomes possible for the sensor 100 to accurately measure the amount of acetone in, for example, a patient's breath.

### Non-Limiting Example Equipment and Techniques

As stated, ruthenium nanoparticles can be deposited on the CuO nanowire sensor using a magnetron sputtering gas condensation system. In an embodiment, a Mantis nanogen trio can be used for this, although other systems could also be used. In the embodiments herein, an inert gas flow (in this case Ar and He) is used to both sputter atoms from an Ru origin, and subsequently condense ejected Ru atoms into Ru nanoparticles 804. Once formed, the differential pressure between an aggregation zone\chamber 850 and a deposition chamber (main chamber) 854 allows the nanoparticles 804 to fly and subsequently land on the CuO nanowire sensor. The base pressure of the deposition chamber 854 was in the low 10⁻⁸ mbar range, while during deposition the aggregation zone and the deposition (main) chamber pressures were maintained at the 10⁻¹ and 10⁻⁴ mbar range respectively. This process is shown at least within FIGS. 8A and 8B.

Gas measurements were conducted in a closed cycle cryogenic probe station (ARS). Before the gas measurements, the chamber was vacuumed to a base pressure in the range of 10⁻³ hPa, using for example a Pfeiffer Vacuum Hi Cube. Following this, 1000 sccm (measured with a Bronkhorst MFC EL-FLOW Select) of dry synthetic air (80%-20%, N₂—O₂) was flowed into the chamber for 12 minutes to bring the chamber back to atmospheric pressure. During the measurements, the sensor was held at a constant temperature using a hotplate and a LakeShore 336 temperature controller. The responses of the sensor 100 was recorded as a current reading against a bias voltage of 0.5V, in an embodiment using a Keithley 2636A SYSTEM Source meter dual channel multimeter. The multimeter was contacted to the sensor 100 via gold coated needles which were in turn connected to the plurality of thin film gold contacts within the sensor 100.

The measurements of the sensor 100 shown in FIGS. 3A/3B and 6A/6B were structured by having a 5-hour stabilisation period pre-measurement, during which 1000 sccm of synthetic dry air was flowed into and out of the system. This would be followed by 15 minutes of gas flow of acetone (10.1 ppm in N₂ solvent gas). A 15-minute recovery period would then follow where the acetone MFC is closed off, meaning no acetone gas is flowed. After this the next test cycle (featuring a higher concentration) would occur. Four such cycles occurred during sensor measurements, leaving measurements to run 7 hours. These measurements were automated using a LabVIEW program, interfaced with the temperature controller and multimeter.

### ADVANTAGES

The underlying copper oxide nanowire sensors can be fabricated on a wafer scale using, in an embodiment, a Si (100) wafer with a 300 nm coating of SiO₂. The sensors can be fabricated in a class 1000 clean room using maskless photolithography. In an embodiment, a Dlight DL-1000GS/OIC by Nano System Solutions can be used to pattern microlayer structures, before materials were deposited using an e-beam vapour deposition (e.g. KE604TT1-TKF1 by Kawasaki Science). However, other mechanisms could also be used, and these examples or provided for enablement and clarity only.

In an embodiment, a cleanroom based, silicon technology compatible, lithographic process is used. First, maskless lithography is used to pattern a photoresist. Then, nanowires are grown through thermal oxidation. As such, fabrication is easy and inexpensive. Further, upon integration into CMOS device, nanowire growth can still be controllable.

The embodiments herein take advantage of the fact that acetone is a potential biomarker in multiple diseases including but not limited to ketosis, heart failure, and/or diabetes. The embodiments herein facilitate breath detection, which may allow a more non-invasive diagnosis than other testing methods. It would be an advancement to achieve non-invasive diagnostics that are effective and reliable. Further, the embodiments herein are especially helpful for situations, sensors, and detectors requiring low detection limits (down to 100 ppb) and silicon technology compatible fabrication process.

With the embodiments herein, detection usually in sub-ppm range, thus lowering the detection limit of the nanowires 104. This in turn improves the resolution of the overall sensor device 100.

Metal oxide sensor (MOx) nanostructures are chosen because their nanostructures have high surface areas allowing more interactions, provide high sensitivity, and also allow fast response times. Additionally, MOx are a well understood sensor technology relying on simple resistance measurements (i.e. easy miniaturisation). Next, MOx sensors can be built from low-cost materials.

However, it is also recognized that MOx nanostructures do have limitations. MOx are often cross sensitive to many gases. Further, many fabrication methods are based on chemical methods or methods requiring temperature not supported by silicon technology, thereby creating issues integrating nanostructures into chips. Also, subsequent batch-to-batch control is difficult. Further, MOx require energy for heating or exciting nanostructures.

In an embodiment, a physical sensor device 100 for delivery to customers could be a chip containing four sensors 100. Each sensor 100 consists of 2 gold electrodes bridged by CuO nanowires. CuO nanowires are decorated using Ru nanoparticles.

### APPENDIX A: VARIOUS ASPECTS OF THE INVENTION

### Method of Fabrication

FAB1. A method of fabricating a sensor, comprising:

fabricating a substrate on a Si wafer with a SiO₂ layer;

depositing an adhesion Ti layer on the SiO₂ layer;

depositing a layer of Au on the Ti layer, the Au layer serving as electrical contacts;

depositing a layer of Ti on the Au and SiO₂ layers, the Ti layer acting as a diffusion barrier for a Cu layer;

positioning a gap within the Cu layer, thereby forming two electrodes on either side of the gap;

growing nanowires between the two electrodes; and

the nanowires bridging the gap between the Cu electrodes through the growth of nanowires between the two electrodes.

FAB2. The method of Fab 1, further comprising:

thermally oxidising the Cu in an ambient atmosphere.

FAB3. The method of Fab 1, further comprising:

the nanowires being formed of CuO.

FAB4. The method of Fab 1, further comprising:

bridging the gap between the copper oxide regions by nanowires forming a high resistance (e.g. 10's of GΩ) semi-conducting path.

FAB5. The method of Fab 1, further comprising:

decorating the nanowires with nanoparticles thereby increasing a response ‘r’ of the nanowire.

FAB6. The method of Fab 5, further comprising:

the decorating occurring with nanoparticles having a narrow size distribution.

FAB7. The method of Fab 5, further comprising:

the decorating occurring while a pressure of an aggregation zone of a sputtering system is in a range of about 10⁻¹ mbar.

FAB8. The method of Fab 5, further comprising:

the decorating occurring while a pressure of a deposition chamber of a sputtering system is in a range of about 10⁻⁴ mbar.

FAB9. The method of Fab 5, further comprising:

forming the nanoparticles from ruthenium.

FAB10. The method of Fab 9, further comprising:

the ruthenium nanoparticles being catalytically active with the nanowires.

FAB11. The method of Fab 10, further comprising:

depositing the ruthenium nanoparticles directly on the nanowires for a predetermined period of time.

FAB12. The method of Fab 11, further comprising:

the predetermined period being 100 minutes.

FAB13. The method of Fab 10, further comprising:

depositing the ruthenium nanoparticles directly on the nanowires for a predetermined amount of surface area of the nanowires.

FAB14. The method of Fab 13, further comprising:

the predetermined amount of surface area being 6%.

FAB15. The method of Fab 13, further comprising:

the step of depositing being achieved using a magnetron sputterer which facilitates inert gas condensation.

FAB16. The method of Fab 15, further comprising:

growing the nanoparticles using Argon gas condensation;

flowing an inert gas around an origin causing atoms to coalesce into nanoclusters.

FAB17. The method of Fab 15, further comprising:

arranging a pressure differential between a growth chamber and a substrate (aggregation) chamber of the magnetron sputterer thereby forcing the nanoclusters to move from origin to the nanowire substrate.

FAB18. The method of Fab 17, further comprising:

generating the nanoclusters using evaporative sources and laser ablation methods.

FAB19. The method of Fab 17, further comprising:

selecting the material used within the nanoparticles based on size distribution and ability to cover a predetermined percentage of the surface area of the sensor.

FAB20. The method of Fab 19, further comprising:

the material used within the nanoparticles being ruthenium.

FAB21. The method of Fab 20, further comprising:

arranging that the Ru nanoparticles are free from surfactants.

FAB22. The method of Fab 1, further comprising:

depositing the nanoparticles on the nanowire sensor using a magnetron sputtering gas condensation system.

FAB23. The method of Fab 16, further comprising:

using an inert gas flow (in this case Ar and He) is used to sputter the atoms from an origin.

FAB24. The method of Fab 1, further comprising:

fabricating the underlying copper oxide nanowire sensors on a wafer scale using a Si wafer with a coating of SiO₂ utilizing a cleanroom based, silicon technology compatible, lithographic process; and

patterning a photoresist with maskless lithography.

FAB25. The method of Fab 24, further comprising:

growing the nanowires through thermal oxidation; and

after integration into CMOS device, continuing to control growth of the nanowire.

### Method of Use

USE1 A method of using a sensor, comprising:

in a situation requiring only moderate selectivity, operating the sensor at a first predetermined temperature where the sensor consumes minimal power;

in a situation requiring greater selectivity, operating the sensor at a second predetermined temperature, where the second predetermined temperature is higher than the first predetermined temperature, such that the sensor consumes more power.

USE2 The method of Use 1, further comprising:

passing acetone across the surface of the sensor;

when as acetone reacts with surface oxide on the sensor, removing oxygen from the surface of the sensor; such that

as the oxygen is removed, the resistance is increased.

USE3 The method of Use 2, further comprising:

continuously measuring a current moving through the sensor;

as resistance increases, the current is reduced, thereby achieving accurate measurements of resistance of the sensor.

USE4 The method of Use 1, further comprising:

arranging that the amount of resistance is directly proportional to the amount of acetone flowing by the sensor; thereby

measuring the amount of acetone flowing by the sensor.

### Method of Testing

TEST1 A method of testing a sensor, comprising:

subjecting a pristine nanowire sensor to acetone gas at a plurality of operating temperatures and concentrations of acetone;

obtaining a response to acetone at the plurality of temperatures;

decorating the pristine nanowire with nanoparticles;

re-subjecting the nanowire to acetone gas; and

comparing the differences between the test results between the pre-decorated and post-decorated stages.

TEST2 The method of Test 1, further comprising:

the concentrations of acetone being one of 50 ppb, 100 ppb, or 200 ppb.

TEST3 The method of Test 1, further comprising:

verifying a Hexagonal Close Packed (HCP) structure of the nanoparticles using a high magnification; and

confirming the HCP structure of the nanoparticles using the Fast-Fourier Transform.

TEST4 The method of Test 1, further comprising:

confirming distribution of nanoparticles on a sensor before gas testing using scanning electron microscopes;

confirming distribution of nanoparticles on that same sensor after gas testing using scanning electron microscopes; and

comparing the two distributions.

TEST5 The method of Test 1, further comprising:

testing the sensor at a variety of temperatures;

determining which temperature produces the most consistent linear average response ‘r’; and

determining which temperature produces the most unified standard deviation.

TEST6 The method of Test 1, further comprising:

varying the concentrations of acetone to be one of 10 ppb, 25 ppb, 50 ppb or 100 ppb.

TEST7 The method of Test 1, further comprising:

conducting the gas measurements in a closed cycle cryogenic probe station.

TEST8 The method of Test 1, further comprising:

vacuuming the chamber to a base pressure in a predetermined range;

flowing dry synthetic air into the chamber for a predetermined amount of time, thereby bringing the chamber back to atmospheric pressure;

holding the sensor at a constant temperature using a hotplate and a LakeShore 336 temperature controller; and

recording responses of the sensor as a current reading against a bias voltage of 0.5V.

flowing 15 minutes of gas flow of acetone (10.1 ppm in N₂ solvent gas);

arranging a 15-minute recovery period would then follow where the acetone is closed off, meaning no acetone gas is flowed;

after this the next test cycle (featuring a higher concentration of acetone) would occur. Four such cycles occurred during sensor measurements, leaving measurements to run 7 hours.

measuring a release of negative charge with dry air;

measuring a release of negative charge with a combination of dry air and acetone; and

comparing the two.

### Apparatus

APP1. A sensor device, comprising:

the sensor being fabricated on a substrate of a wafer having a SiO₂ layer;

an adhesion layer located on the SiO₂ layer;

an electrode layer located on top of the SiO2 layer, to serve as electrical contacts;

a layer of Ti located partially on the Au and SiO₂ layers to acting as a diffusion barrier for a Cu layer;

a gap formed in the contact layer, thereby separating the electrode layer into two electrodes; and

the gap between the electrodes being bridged through the growth of nanowires therebetween, the growth occurring via thermal oxidization.

APP2. The sensor device of App 1, further comprising:

each sensor consists of a plurality of gold electrodes bridged by CuO nanowires;

the CuO nanowires being decorated with nanoparticles.

APP3. The sensor device of App 1, further comprising:

the sensors being grouped and packaged such that four sensors appear on one chip.

What is claimed is:

1. A method of fabricating a sensor, comprising:
fabricating a substrate on a Si wafer with a SiO₂ layer;
depositing an adhesion Ti layer on the SiO₂ layer;
depositing a layer of Au on the Ti layer, the Au layer serving as electrical contacts;
depositing a layer of Ti on the Au and SiO₂ layers, the Ti layer acting as a diffusion barrier for a Cu layer;
positioning a gap within the Cu layer, thereby forming two electrodes on either side of the gap;
growing nanowires between the two electrodes; and
the nanowires bridging the gap between the Cu electrodes through the growth of nanowires between the two electrodes.

2. The method of claim 1, further comprising:
thermally oxidising the Cu in an ambient atmosphere.

3. The method of claim 1, further comprising:
the nanowires being formed of CuO.

4. The method of claim 1, further comprising:
bridging the gap between the copper oxide regions by nanowires forming a high resistance semi-conducting path.

5. The method of claim 1, further comprising:
decorating the nanowires with nanoparticles thereby increasing a response ‘r’ of the nanowire.

6. The method of claim 5, further comprising:
the decorating occurring with nanoparticles having a narrow size distribution.

7. The method of claim 5, further comprising:
the decorating occurring while a pressure of an aggregation zone of a sputtering system is in a range of about 10⁻¹ mbar.

8. The method of claim 5, further comprising:
the decorating occurring while a pressure of a deposition chamber of a sputtering system is in a range of about 10⁻⁴ mbar.

9. The method of claim 5, further comprising:
forming the nanoparticles from ruthenium.

10. The method of claim 9, further comprising:
the ruthenium nanoparticles being catalytically active with the nanowires.

11. The method of claim 10, further comprising:
depositing the ruthenium nanoparticles directly on the nanowires for a predetermined period of time.

12. The method of claim 11, further comprising:
the predetermined period being 100 minutes.

13. The method of claim 10, further comprising:
depositing the ruthenium nanoparticles directly on the nanowires for a predetermined amount of surface area of the nanowires.

14. The method of claim 13, further comprising:
the predetermined amount of surface area being 6%.

15. The method of claim 13, further comprising:
the step of depositing being achieved using a magnetron sputterer which facilitates inert gas condensation.

16. The method of claim 15, further comprising:
growing the nanoparticles using Argon gas condensation;
flowing an inert gas around an origin causing atoms to coalesce into nanoclusters.

17. The method of claim 15, further comprising:
arranging a pressure differential between a growth chamber and a substrate (aggregation) chamber of the magnetron sputterer thereby forcing the nanoclusters to move from origin to the nanowire substrate.

18. A sensor device, comprising:
the sensor being fabricated on a substrate of a wafer having a SiO₂ layer;
an adhesion layer located on the SiO₂ layer;
an electrode layer located on top of the SiO2 layer, to serve as electrical contacts;
a layer of Ti located partially on Au and SiO₂ layers to act as a diffusion barrier for a Cu layer;
a gap formed in the electrode layer, thereby separating the electrode layer into two electrodes; and
the gap between the electrodes being bridged through the growth of nanowires therebetween, the growth occurring via thermal oxidization.

19. The sensor device of claim 18, further comprising:
each sensor consists of a plurality of gold electrodes bridged by CuO nanowires;
the CuO nanowires being decorated with nanoparticles.

20. The sensor device of claim 18, further comprising:
the sensors being grouped and packaged such that four sensors appear on one chip.
